(19) United States
(12) Patent Application Publication
(10) Pub. No.: US 2007/0098106 A1
(43) Pub. Date: May 3, 2007

(54) QUANTIZED MULTI-RANK BEAMFORMING WITH STRUCTURED CODEBOOK FOR MULTIPLE-ANTENNA SYSTEMS

(76) Inventors: Mohammad Ali Khojastepour, Plainsboro, NJ (US); Xiaodong Wang, New York, NY (US); Mohammad Madihian, Plainsboro, NJ (US)

Correspondence Address: BROSEMER, KOLEFAS & ASSOCIATES, LLC (NECL), ONE BETHANY ROAD BUILDING 4 - SUITE #58, HAZLET, NJ, 07730, US

(21) Appl. No.: 11/554,278

(22) Filed: Oct. 30, 2006

Related U.S. Application Data
(60) Provisional application No. 60/731,658, filed on Oct. 31, 2005.

(51) Int. Cl. H04L 1/02

(52) U.S. Cl. 375/267

(57) ABSTRACT

A quantized multi-rank beamforming technique that is adapted based on feedback from a receiver containing information that captures the existence of multiple transmission modes of the channel between the transmitter and receiver. The modes of the channel can be represented by a set of orthonormal eigenvectors. Rank selection chooses the optimum number of modes for transmission in order to maximize the transmitted rate or guarantee the highest reliability based on the channel state information provided through the feedback link. In order to fully exploit the feedback, which is typically limited, different codebooks for different ranks are provided. Such a rank-specific codebook design can considerably improve the performance by allowing finer quantization of the transmission space. Power control across the various modes can also be provided. A power control strategy assigns a different fraction of the transmit power to each mode based on the feedback. The power control information can be included in the codebooks.

### CROSS REFERENCE TO RELATED APPLICATIONS

This application claims the benefit under 35 U.S.C. § 119(e) of U.S. Provisional Application No. 60/731,658, filed Oct. 31, 2005, the entire contents of which are hereby incorporated by reference for all purposes into this application.

### FIELD OF THE INVENTION

The present invention relates to the field of wireless communications, particularly wireless, high-rate communications using multiple-antenna systems.

### BACKGROUND INFORMATION

The hostility of the wireless fading environment and channel variation makes the design of high rate communication systems very challenging. To this end, multiple antenna systems have shown to be very effective in fading environment by providing significant performance improvements and achievable data rates in comparison to single antenna systems. The performance gain achieved by multiple antenna system increases when the knowledge of the channel state information (CSI) at each end, either the receiver or transmitter, is increased. Although perfect CSI is desirable, practical systems are usually built only on estimating the CSI at the receiver, and possibly feeding back the CSI to the transmitter through a feedback link with a very limited capacity. Using CSI at the transmitter, the transmission strategy is adapted over space (multiple antennas) and over time (over multiple blocks).

One issue to address is the problem of space adaptation through the design of multi-rank beamforming. Known approaches to such space adaptations for multiple-antenna systems include space-time coding, precoding and beamforming.

One area in which the aforementioned considerations have arisen is in UMTS Terrestrial Radio Access Network (UTRAN) and Evolved-UTRA, which call for higher user data rates and improved quality of service. A number of proposals have discussed and concluded the need for multiple-antenna systems to achieve the target spectral efficiency, throughput, and reliability of EUTRA. These proposals have considered different modes of operation applicable to different scenarios. The basic assumptions that vary among proposals include (i) using single stream versus multiple streams, (ii) scheduling one user at a time versus multiple users, (iii) having multiple streams per user versus a single stream per user, and (iv) coding across multiple streams versus using independent streams. A common factor among various downlink physical layer multiple-input-multiple-output (MIMO) proposals, however, is a feedback strategy to control the transmission rate and possibly vary the transmission strategy.

While the proposals for the use of multiple-antenna systems in downlink EUTRA such as PARC, PSRC, PGRC, PUSRC, PU2RC, SCW, MCW, SDM, SDMA, and current transmit diversity schemes in 3GPP release 6 such as STD, STTD, and TxAA differ in terms of the system description, they all share the following features: (i) possible multiplexing of streams to multiple streams; (ii) possible use of linear precoding of streams before sending to antennas; (iii) possible layering of the streams between the antennas; and (iv) rate control per stream or multiple jointly coded streams.

It has been noted that the proposals for EUTRA should not increase the transmission modes unnecessarily and should be realistic in terms of implementation, particularly considering user equipment (UE) complexity. Moreover, the proposed transmission strategy should appropriately address the effect of channel estimation error and feedback error and impact of receiver structure.

### SUMMARY OF THE INVENTION

The present invention is directed to quantized multi-rank beamforming methods and apparatus. In an exemplary embodiment of the present invention, a beamforming transmission method for a multi-antenna communications system comprises: estimating a channel over which the multi-antenna communications system is to operate; determining a number of signal streams to be transmitted based on the estimated channel; determining an eigenvector corresponding to each signal stream; quantizing each eigenvector to determine a corresponding quantized eigenvector; and transmitting each of the signal streams in accordance with the corresponding quantized eigenvector. In an exemplary embodiment, the channel is estimated at a receiver, which also determines the eigenvectors to be used for each signal stream. The receiver further quantizes the eigenvectors and feeds-back information relating to the quantized eigenvectors to the beamforming transmitter. The information may also include information regarding the allocation of power over the various eigenvectors.

Embodiments of the present invention can considerably outperform known beamforming and precoding techniques for different transmission rates. Exemplary embodiments of the present invention can be implemented with low impact on base station and user equipment (UE) complexity and with low feedback rates between the receiver and transmitter.

As will be shown, the quantized multi-rank beamforming scheme of the present invention is significantly superior to other known techniques of space adaptation for multiple-antenna systems, including, for example, space-time coding, full-rank preceding, and conventional or unit-rank beamforming. While quantized full-rank precoding was introduced as a high rate transmission strategy, quantized unit-rank beamforming has been considered to provide better coverage and reliability. By outperforming both quantized unit-rank beamforming and quantized full-rank preceding, the quantized multi-rank beamforming scheme of the present invention provides both reliability and high rate transmission in the regimes that they are needed.

The aforementioned and other features, aspects and advantages of the present invention are described in greater detail below.

### BRIEF DESCRIPTION OF THE DRAWINGS

FIG. 1 is a schematic block diagram of a multiple-antenna communications system with quantized feedback of channel state information.

FIG. 2 shows a graph of outage probability versus signal-to-noise-ratio (SNR) for four different transmission strategies for a multiple-antenna system with three transmit antennas and two receive antennas and a transmission rate of 2.

FIG. 3 shows a graph of outage probability versus signal-to-noise-ratio (SNR) for four different transmission strategies for a multiple-antenna system with three transmit antennas and two receive antennas and a transmission rate of four.

FIG. 4 shows a graph of outage probability versus signal-to-noise-ratio (SNR) for four different transmission strategies for a multiple-antenna system with three transmit antennas and two receive antennas and a transmission rate of six.

FIG. 5 shows a graph of frame error probability versus signal-to-noise-ratio (SNR) for exemplary embodiments of quantized multi-rank beamforming with and without power control for a multiple-antenna system with three transmit antennas and two receive antennas operating with a transmission rate of four.

FIG. 6 shows a graph of outage probability versus signal-to-noise-ratio (SNR) for quantized multi-rank beamforming using different bit allocations for the quantization of eigenvectors with fixed codebook quantization and successive quantization in which eigenvectors are successively quantized in lower dimensions.

FIG. 7 shows a graph of outage probability versus signal-to-noise-ratio (SNR) for quantized multi-rank beamforming using successive multiple codebook beamforming and single codebook beamforming.

FIG. 8 schematically illustrates the dependency of variables in the determination of eigenvectors and quantized eigenvectors and the re-creation of quantized eigenvectors in a successive beamforming scheme implemented in accordance with the present invention.

FIG. 9 shows a sample distribution of a power allocation vector for a rank-2 beamformer.

FIG. 10 shows a graph of outage probability versus signal-to-noise-ratio (SNR) for a precoding scheme and a quantized multi-rank beamforming scheme with and without feedback error of 5%.

FIG. 11 shows a graph of outage probability versus signal-to-noise-ratio (SNR) for a quantized multi-rank beamforming scheme with various combinations of channel estimate delay and channel prediction.

FIG. 12 shows a graph of outage probability versus signal-to-noise-ratio (SNR) for a quantized dominant eigenvector beamforming scheme and two quantized multi-rank beamforming schemes.

FIG. 13 shows a graph of outage probability versus signal-to-noise-ratio (SNR) for a precoding scheme and a quantized multi-rank beamforming scheme.

FIG. 14 shows a graph of outage probability versus signal-to-noise-ratio (SNR) for a space-time coding scheme and a quantized multi-rank beamforming scheme.

FIGS. 15A through C schematically illustrate exemplary codebook structures for rank one, two and k, respectively.

FIG. 16 shows a block diagram of an exemplary embodiment of a base station of a wireless communication system incorporating multi-rank beamforming in accordance with the present invention.

FIG. 17 is a flow-chart illustrating an exemplary interaction between user equipment (UE) and a base station operating in accordance with the present invention.

### DETAILED DESCRIPTION

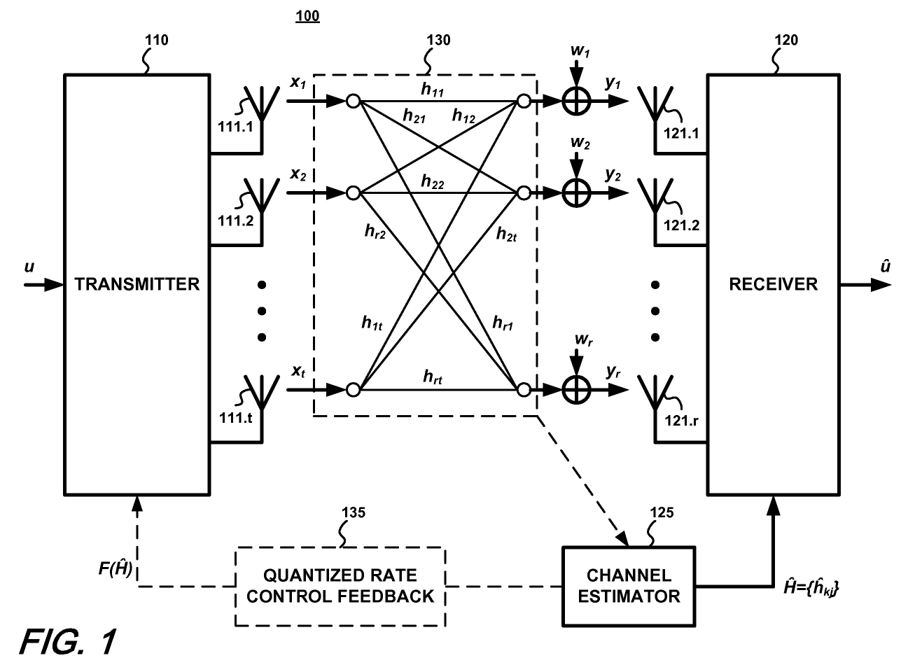

An exemplary multiple-antenna communication system 100 with quantized feedback is schematically shown in FIG. 1. A transmitter 110 transmits from t transmitting antennas 111.1-111.t over a fading channel 130 to r receiving antennas 121.1-121.r coupled to a receiver 120. A channel estimator 125 provides an estimate of the channel 130 to the receiver 120. The channel estimate is also quantized and provided to the transmitter 110 via a quantized rate control feedback channel 135.

For a multiple-antenna system with r receive and t transmit antennas the baseband channel model can be expressed as follows:
Y=HX+W, (1)
where Y is the r×1 received column vector, H is the r×t channel matrix, X is the t×1 transmit column vector, and W is the r×1 noise column vector. The input is subject to an average power constraint P, i.e, tr(Q)≦P, where Q=E[XX^{H}], E[.] denotes the expected value and tr(.) represents the trace of a matrix. A goal of an exemplary space adaptation scheme is to minimize the frame error rate, which tightly follows the outage behavior of the transmission strategy, defined as:
Pₒᵤₜ=Prob{log det(Iₙ+HQH^{H})<R},
s.t. tr(Q)≦P,Q≧0 (2)
where Iₙ is an identity matrix of size n and R is the attempted transmission rate.

In an exemplary multi-rank beamforming scheme in accordance with the present invention, channel state information (CSI) is available to the transmitter (CSIT) as well as the receiver (CSIR). Where perfect CSIT and CSIR are assumed, the capacity of the multiple-antenna fading channel 130 can be achieved through power adaptation over time (one average power for each channel state) and water-filling power control over multiple eigenvectors of the channel for each block of transmission. This translates into power control over multiple antennas in the spatial domain. The nature of the water-filling power control implies that transmission may occur only on a subset of eigenvectors of the channel depending on the channel condition. Therefore, to maximize the system throughput, the number of eigenvectors in which communication occurs, defined as the transmission rank, is controlled. For a given transmission rate, the transmission rank depends on the channel condition, where the transmission rank is at most equal to m=min(t, r). Thus, the set of all channel conditions is divided into m partitions, where the k-th partition represents the channel conditions for which the beamformer rank is equal to k, i.e., transmission occurs only on k eigenvectors of the channel.

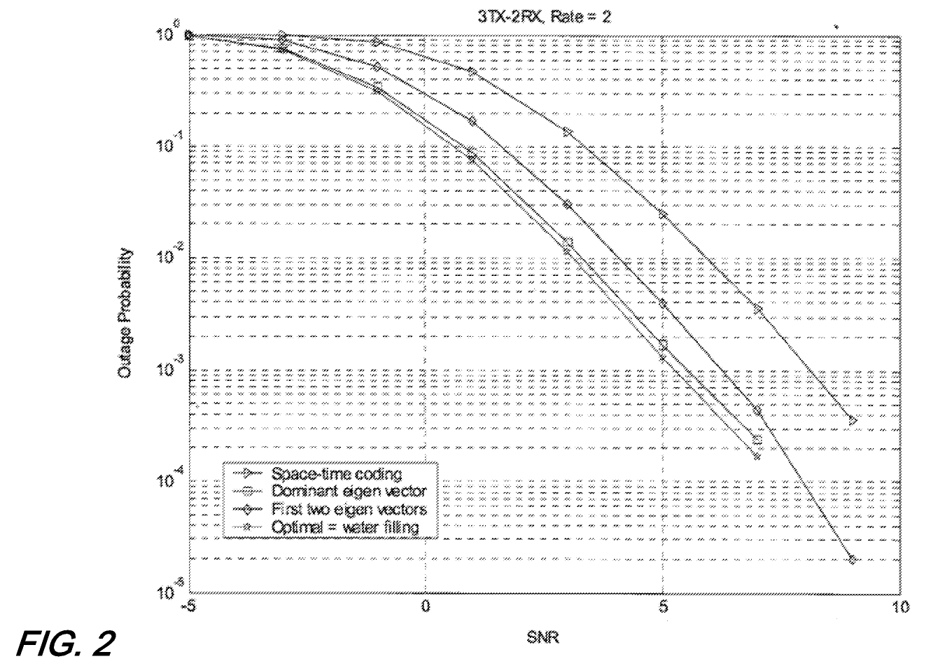

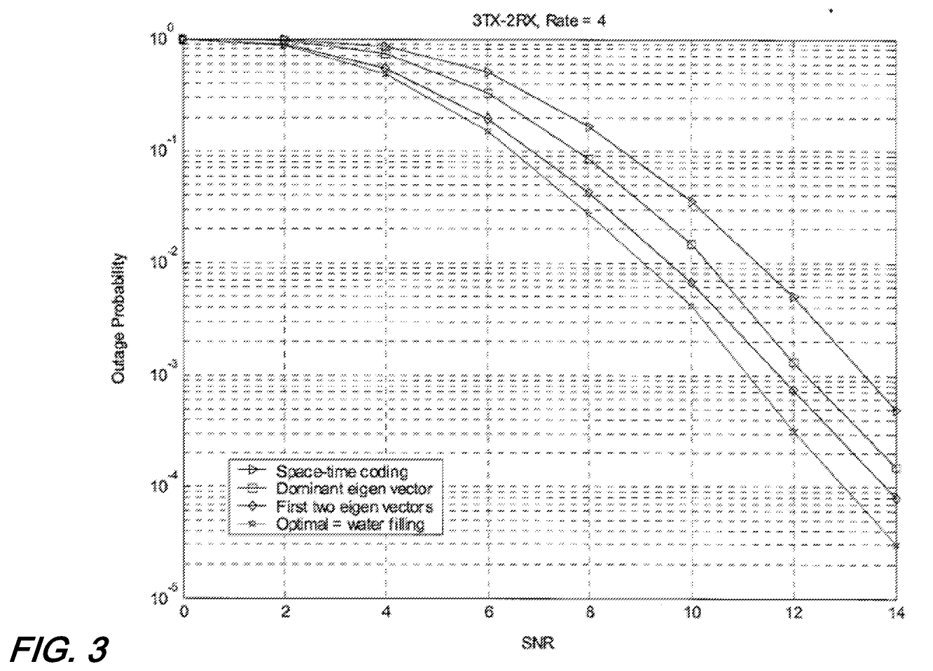

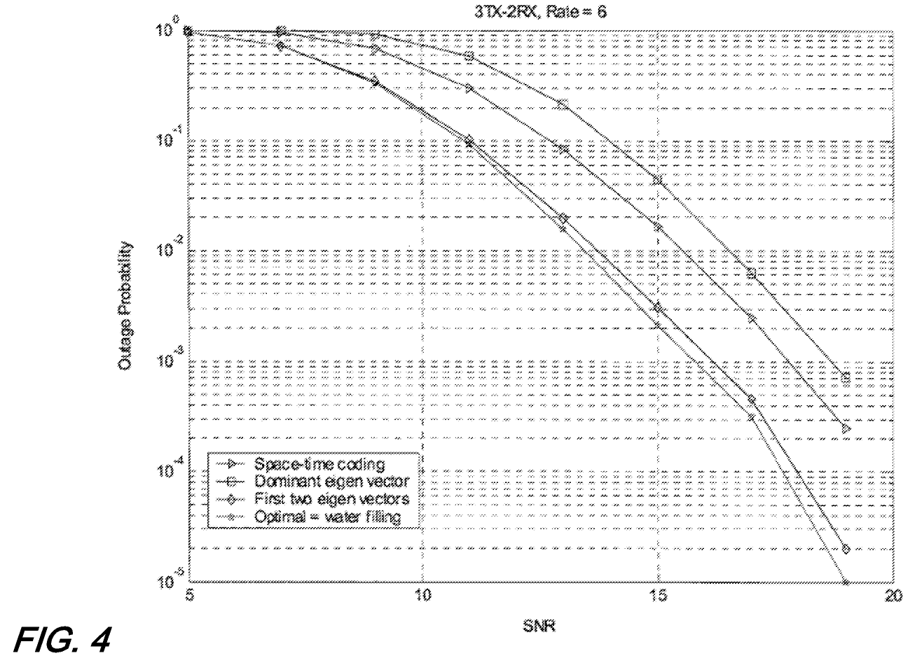

FIGS. 2 through 4 show the importance of controlling the beamforming rank and its effects on the performance of the transmission scheme. FIGS. 2-4 show the comparative performance of a 3×2 multiple-antenna system (i.e., 3 transmitting antennas and 2 receiving antennas) under four different transmission strategies. The first transmission strategy uses a space-time coding that does not require CSIT, whereas the other three transmission strategies are based on perfect CSIT: dominant-eigenvector beamforming (rank-1 beamforming); rank-2 beamforming without power control across eigenvectors; and rank-2 beamforming with water-filling power control over eigenvectors. As the transmission rate increases from 2 bits per channel use (FIG. 2) to 4 (FIG. 3) and then to 6 (FIG. 4), the relative performance of the four transmission schemes changes. This suggests that lower rank beamforming is more effective for lower transmission rates, whereas higher rank beamforming is more effective for higher transmission rates. As described in greater detail below, the present invention provides an adaptive multi-rank, quantized beamforming scheme which adapts to the channel conditions.

Rank control becomes even more vital for practical systems such as that of FIG. 1 in which CSIT is only available through a low-rate feedback 135 from the receiver. This is because choosing a lower rank not only results in better performance under some channel conditions, but also because the quantization of the eigenvectors of the channel and their respective power control becomes more accurate where a smaller number of eigenvectors are to be fed back.

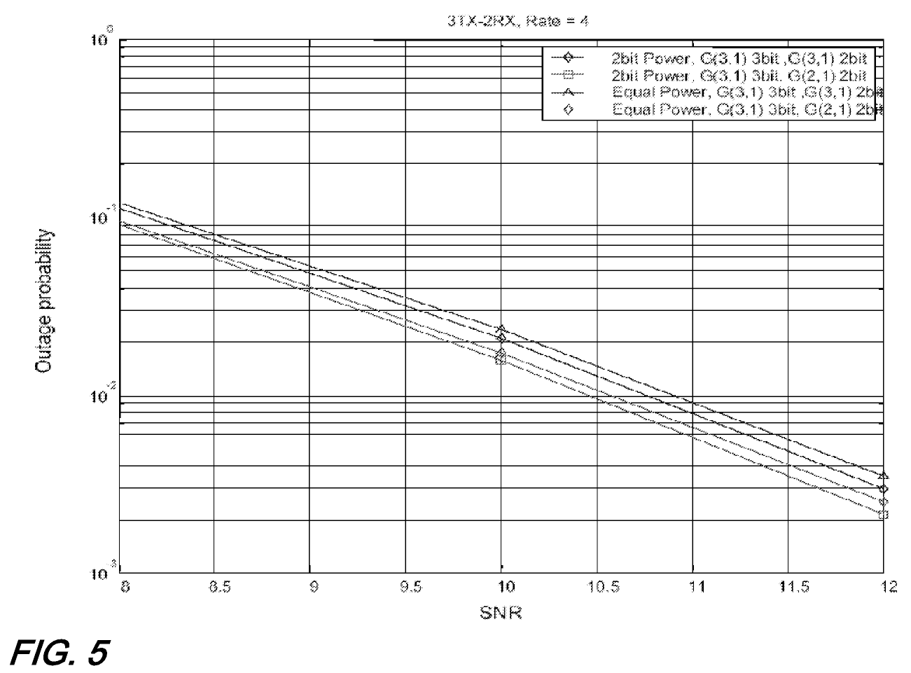

In a further aspect of the present invention, the transmission power over each eigenvector of the channel is controlled. In all of FIGS. 2-4 it can be seen that the transmission strategy with power control achieves almost a 1 dB gain over the transmission strategies in which no power control is performed. The same is true for an exemplary transmission strategy, in accordance with the present invention, which employs quantized multi-rank beamforming as described in greater detail below. FIG. 5 shows the performance of such a scheme. The expression ‘G(a,b) N-bits’ in the legends denotes that the corresponding scheme uses a codebook of size 2^{N} chosen from packing in Grassmanian manifold G(a,b).

FIG. 5 shows a graph of frame error probability versus signal-to-noise-ratio (SNR) for exemplary embodiments of quantized multi-rank beamforming with and without power control for a multiple-antenna system with three transmit antennas and two receive antennas operating with a transmission rate of four. FIG. 5 illustrates the performance improvement attained by adding a simple 2-bit power control to a quantized multi-rank beamforming scheme.

In a further aspect of the present invention, the numbers of bits used to quantize each eigenvector and the overall power allocation vector are controlled. Because the number of bits for feedback in each block is limited, how they are used for quantization of the aforementioned vectors is critical. It has been observed that generally more bits should be spent to quantize the more dominant eigenvectors, especially if successive beamforming (described below) is used. The intuitive explanation is that a more dominant eigenvector is quantized in a space with higher dimension, meaning that more bits are required to quantize it in order to have the same effective resolution for all eigenvectors. Moreover, an even higher resolution is helpful for a more dominant eigenvector that is going to be reconstructed at the destination prior to the other eigenvectors because it will directly affect the reconstruction of the other eigenvectors through successive reconstruction.

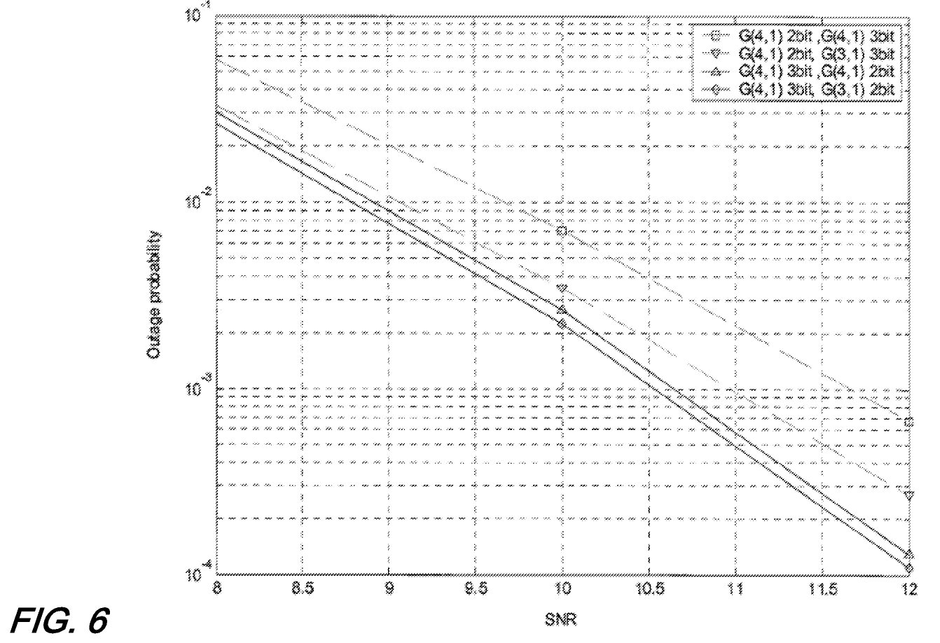

FIG. 6 shows the comparative effect of different bit allocations for the quantization of eigenvectors for an exemplary 3×2 multiple-antenna system. FIG. 6 also shows the effect of successive beamforming. Successive beamforming is based on the observation that the eigenvectors of the channel are all orthogonal. Therefore, if the first eigenvector of the channel is known, the second eigenvector belongs to a lower dimensional space. Thus, if the first eigenvector can be quantized in a t×1 space, the second eigenvector can be quantized in a (t−1)×1 space Quantization of the first eigenvector, however, does not provide perfect knowledge of this lower dimensional space because of the difference between the quantized vector and the original vector.

One approach is to quantize the second dominant eigenvector using the same codebook that is used for the quantization of the first dominant eigenvector. This approach is not optimal, as it does not take advantage of the possibility of quantizing the second eigenvector in the lower dimensional space, which would have allowed a more refined description of the second eigenvector using the same number of bits.

Another approach is to find the lower dimensional space based on the actual dominant eigenvector that is known to the receiver via perfect channel knowledge. Although this lower dimensional space is where the second eigenvector should lie—and therefore it seems that it would be optimal to perform the quantization in this space—there are problems with this second approach. One problem is that perfect knowledge of the channel state is not available to the transmitter and thus the transmitter does not know the actual dominant eigenvector to reconstruct the next eigenvector. The transmitter could use the quantized version of the first dominant eigenvector but this would produce more error because the quantizated dominant eigenvector was not originally used by the receiver to quantize the subsequent eigenvectors. Another problem is that the second quantized eigenvector in this space would not necessarily be orthogonal to the first quantized eigenvector. Practical transmission schemes, however, especially if multiple streams are transmitted on different eigenvectors of the channel, assume the orthogonality of the transmission space for different streams.

In an exemplary embodiment of the present invention, the quantized version of the first eigenvector is used by both the receiver and transmitter in order to reduce the dimension of the space for quantization of the subsequent eigenvectors. Because the receiver successively uses the quantized eigenvectors in order to quantize the subsequent eigenvectors, and these eigenvectors become available to the transmitter through feedback, the reconstruction of all eigenvectors at the transmitter can be done without error. Moreover, it is guaranteed that the second quantized eigenvector is orthogonal to the first eigenvector. Due to its successive structure, this scheme is referred to, herein, as successive quantization.

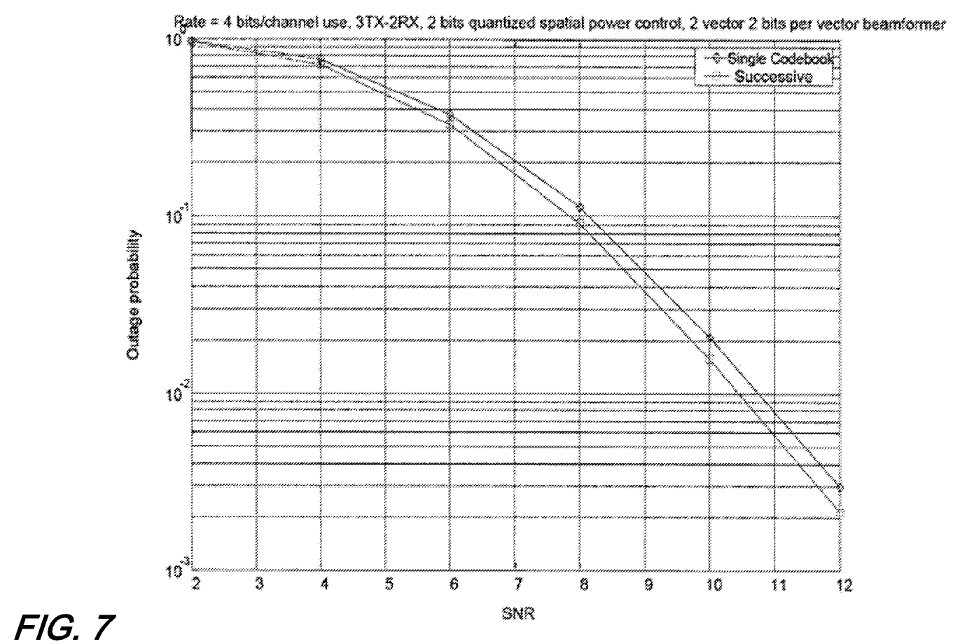

FIG. 7 is a graph of outage probability versus SNR which illustrates the performance gain obtained with an exemplary successive quantization scheme using multiple, successive codebooks relative to that of a single codebook quantization scheme.

The design of an exemplary quantized multi-rank beamforming scheme in accordance with the present invention entails: a) finding an appropriate beamforming rank based on rate; b) designing the successive codebooks and bit allocations; and c) designing power control over eigenvectors. In an exemplary embodiment, the power control may depend on the SNR range of operation. For example, at lower SNRs, the average power used over each eigenvector will preferably differ, whereas at higher SNRs, the power will preferably be relatively equal over all eigenvectors.

In an exemplary embodiment of a quantized multi-rank beamforming scheme in accordance with the present invention, the rank of the beamformer is controlled for different transmission rates.

Let:
H=UDV^{H} (3)
denote the singular value decomposition (SVD) of the instantaneous channel realization H (where D is the diagonal matrix defined by the SVD operation), and where the column of the unitary matrix V=[V⁽¹⁾; V⁽²⁾; . . . ] represents different eigenvectors of the channel for the corresponding eigenvalues given by tr(D).

A multi-rank beamformer with perfect knowledge of the channel states picks k eigenvectors [V⁽¹⁾; V(²⁾; . . . ; V^{(k)}] of the channel that correspond to the first k largest eigenvalues of the channel. The transmitted signal is in the form of:
X=[V⁽¹⁾;V⁽²⁾; . . . ;V^{(k)}][x₁\sqrt{P₁},x₂\sqrt{P₂}, . . . xₖ\sqrt{Pₖ}]^{T}, (4)
where x₁, x₂, . . . , xₖ represent k different signal streams transmitted through k eigenvectors of the channel with corresponding power allocations P₁, P₂, . . . , Pₖ. In an exemplary embodiment, the power allocations are determined through water-filling:

$${P}_{i} = {( μ - \frac{1}{{d}_{i}} )}^{+} , \qquad ( 5 )$$

where dᵢ is the i'th element of the diagonal matrix D defined by SVD operation in (3) and μ is obtained such that

$${\sum }_{i = 1}^{k} {P}_{i} = P .$$

The operation (.)⁺ takes the positive part defined as
(x)⁺=x, x>0=0, x≦0.

In an exemplary quantized multi-rank beamfoming scheme of the present invention, the quantized version of the eigenvectors, C⁽ⁱ⁾'s (referred to herein as quantized eigenvectors), are fed back to the transmitter instead of the actual eigenvectors V⁽ⁱ⁾'s. A joint codebook is shared by the transmitter and the receiver and preferably only the index of the quantized eigenvectors are fed back to the transmitter. The transmitter then uses the received indices to look up the quantized eigenvectors in the joint codebook, which quantized eigenvectors the transmitter uses for transmission.

For example, the transmitted signal for a rank-2 beamformer can be expressed as
X=x₁\sqrt{P₁}C⁽¹⁾+x₂\sqrt{P₂}C⁽²⁾. (6)
Therefore, the receiver picks two quantized eigenvectors, C⁽¹⁾εG₁ and C⁽²⁾εG₂ from the codebooks G₁ and G₂ in order to minimize the outage probability, Pₒᵤₜ(R,P₁,P₂|C⁽¹⁾,C⁽²⁾), s.t.P₁+P₂=P.

In order to minimize the outage probability, it is shown that the quantized eigenvectors C⁽¹⁾ and C⁽²⁾ are given by:

$$\begin{matrix}{max}_{{C}^{( 1 )} ∈ {G}_{1}} {\vert < {V}^{( 1 )} , {C}^{( 1 )} > \vert}^{2} , and & ( 6 ) \\ {max}_{{C}^{( 2 )} ∈ {G}_{2}} {\vert < {V}^{( 2 )} , {C}^{( 2 )} > \vert}^{2} . & ( 7 )\end{matrix}$$

Each quantized eigenvector C⁽¹⁾ and C⁽²⁾ is a t×1 vector where t is the number of transmit antennas. Therefore, designing a codebook G can be treated as packing vectors in Grassmanian Manifold G(t,1)=C^{t}, defined as:

$${min}_{G = \{ {C}_{1} , {C}_{2} , … , {C}_{n} \}} [ {max}_{{C}_{i} , {C}_{j} ∈ C , {C}_{i} \neq {C}_{j}} {\vert < {C}_{i} , {C}_{j} > \vert}^{2} ] \qquad ( 8 )$$

The present invention provides a more efficient design based on the fact that the eigenvectors of the channel are orthogonal. Because V⁽²⁾⊥V⁽¹⁾, the second eigenvector V⁽²⁾ can be quantized in space C^{t-1} instead of space C^{t}, thus, the codebook can be designed more efficiently and overall performance improved considerably. In an exemplary embodiment, the quantization of the first dominant eigenvector V⁽¹⁾, is performed as before by:

$${max}_{{C}^{( 1 )} ∈ {G}_{1}} {\vert < {V}^{( 1 )} , {C}^{( 1 )} > \vert}^{2} \qquad ( 9 )$$

A rotation matrix φ is then chosen such that:
φC⁽¹⁾=u₁≡[1;0;0; . . . ;0]. (10)
Using a contraction operator T_{C}:Cⁿ→Cⁿ⁻¹, defined as T_{C}([v₁, v₂, . . . vₙ])[v₂, . . . , vₙ], the quantization of the second vector can be modified as follows:

$${max}_{{C}^{( 2 )} ∈ {G}_{2}} {\vert < {T}_{C} ( ϕ ( {C}^{( 1 )} ) {V}^{( 2 )} ) , {C}^{( 2 )} > \vert}^{2} \qquad ( 11 a )$$

Note that while the contraction operator T_{C}:Cⁿ→Cⁿ⁻¹ is used at the receiver to quantize V⁽²⁾, an expansion operator T_{E}:Cⁿ⁻¹→Cⁿ, defined as T_{E}([v₂, . . . Vₙ])[=0, v₂, . . . , vₙ] is used at the transmitter to re-create the corresponding transmit beamforming vector as follows:
\tilde{C}⁽²⁾=inv(φ(C⁽¹⁾))T_{E}(C⁽²⁾). (11b)
The transmitter uses C⁽¹⁾ as a beamforming vector to transmit the first signal stream xᵢ and \tilde{C}⁽²⁾ as a beamforming vector to transmit the second signal stream x₂.

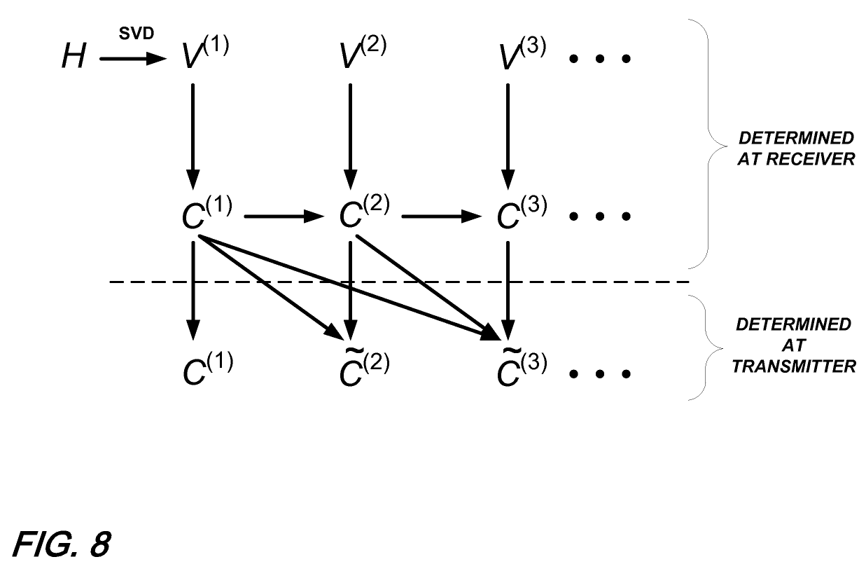

Using this approach, the cardinality of the space required to pack the subsequent eigenvectors decreases by one for each successive eigenvector. FIG. 8 shows the dependency of the variables and the way the successive beamforming is performed. Using the channel matrix H, the SVD is computed to find the actual eigenvectors V⁽¹⁾, V⁽²⁾, . . . V⁽¹⁾ is then quantized to find C⁽¹⁾. Then, using C⁽¹⁾, V⁽²⁾ is quantized in a lower dimensional space to find C⁽²⁾. Using C⁽¹⁾ and C⁽²⁾, V⁽³⁾ is then quantized and so on. The actual eigenvectors V⁽¹⁾, V⁽²⁾, . . . and quantized eigenvectors C⁽¹⁾, C⁽²⁾, . . . are determined at the receiver, whereas the corresponding transmit beamforming vectors \tilde{C}⁽²⁾, \tilde{C}⁽³⁾, . . . are re-created at the transmitter. Note that the quantized eigenvector C⁽¹⁾ is provided directly to the transmitter.

As discussed above, another important aspect of multi-rank beamforming is the quantized power allocation P=(P₁, P₂, . . . , Pₖ) across the eigenmodes. This is derived by solving a standard vector quantization problem given as follows:

$${{min}_{\underline{P} = ( {P}_{1} , {P}_{2} , … , {P}_{k} ) , {P}_{i} ↔ {ℋ}_{i}}}_{{\sum }_{i = 1}^{k} {P}_{i} = P} {E}_{H} [ Pr \{ log det ( I + HQ ( \underline{P} ) {H}^{H} ) < R \} ] , \qquad ( 12 )$$

where:
Q(P)=[C₁;C₂; . . . ;Cₖ]^{H}diag(P)[C₁;C₂; . . . ; Cₖ] (13)

The quantization of the power allocation vector can be considerably simplified by using the probability distribution of the power allocation vector for the optimal (not quantized) water-filling approach. This approach considerably reduces design complexity by finding the answer to the following problem:

$${{min}_{\underline{P} = ( {P}_{1} , {P}_{2} , … , {P}_{k} ) , {P}_{i} ↔ {ℋ}_{i}}}_{{\sum }_{i = 1}^{k} {P}_{i} = P} {E}_{H} [ Pr \{ log det ( I + HQ ( \underline{P} ) {H}^{H} ) < R \} ] , \qquad ( 12 )$$

where:
Q(P)=[V₁;V₂; . . . ;Vₖ]^{H}diag(P)[V₁;V₂; . . . ;Vₖ]. (14)

Because the solution to the above power allocation depends on the channel condition and the channel condition is a random variable, the power allocation vector is also a random variable for which we can find its probability distribution. This distribution can then be used to find a quantized set of power allocation values. An exemplary strategy is to use equal probability partitions for the power allocation vectors and use the median of the power allocation vector in each partition.

The solution to the above vector quantization problem is practically close to the solution of the original power quantization problem and its effect on the relative performance loss for quantized multi-rank beamforming is usually negligible.

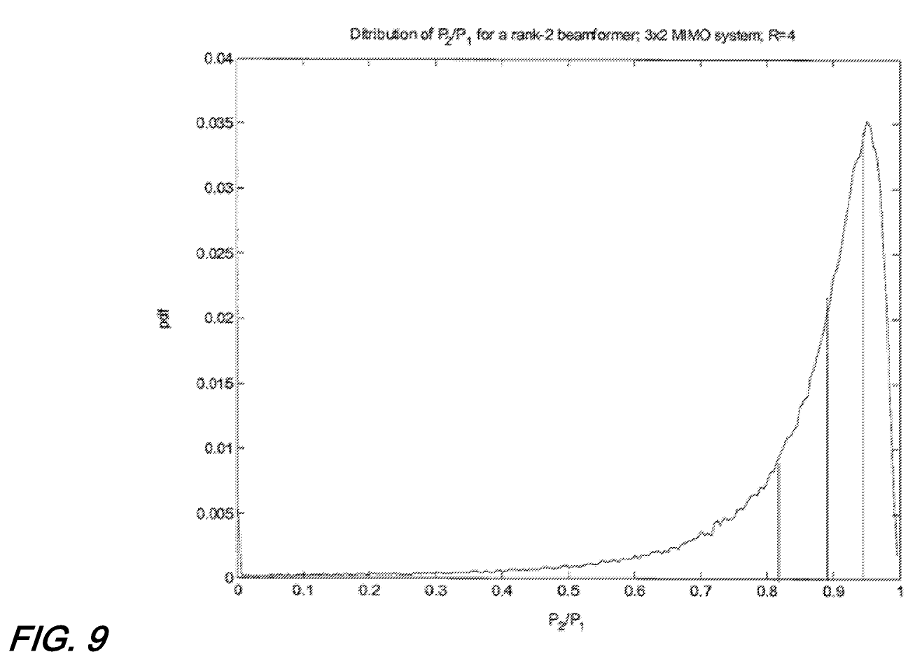

FIG. 9 shows the distribution of the power allocation vector for an exemplary rank-2 beamformer and possible partitioning of the vectors into four partitions that requires two bits to feedback.

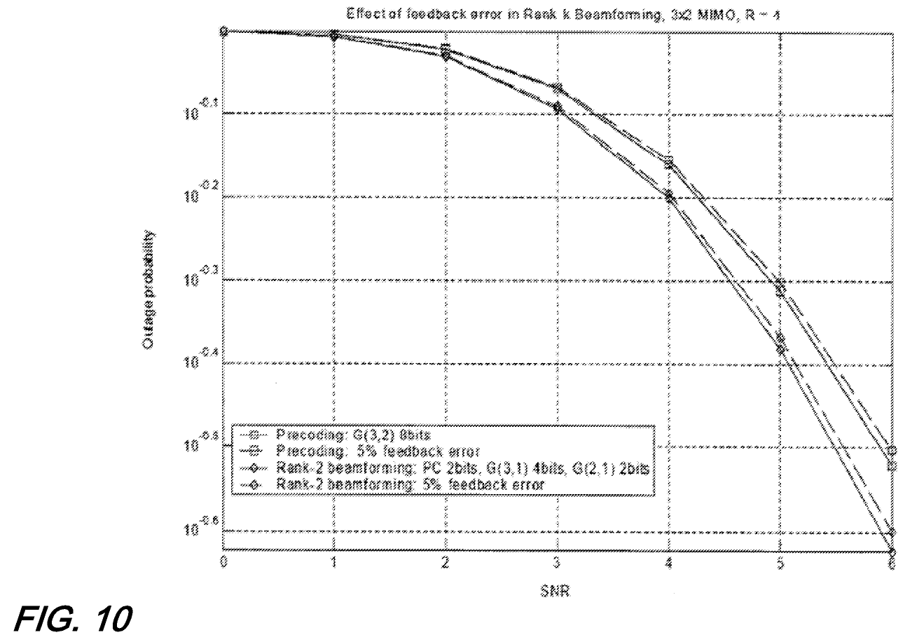

The exemplary multi-rank beamforming scheme in accordance with the present invention is very robust with respect to errors in the feedback link. FIG. 10 shows that the resultant degradations from relatively high feedback link error rates (e.g., 5%) are relatively modest.

Channel estimation error, however, considerably affects the performance of multi-rank beamforming. Such degradation in performance may completely overtake the possible gain from multi-rank beamforming. To reduce such degradation, however, an exemplary embodiment adds a prediction step in estimating the current channel. The prediction can be a relatively simple linear prediction based on several past measurements of the channel. Using such prediction, the lost gain due to the presence of estimation error is significantly restored.

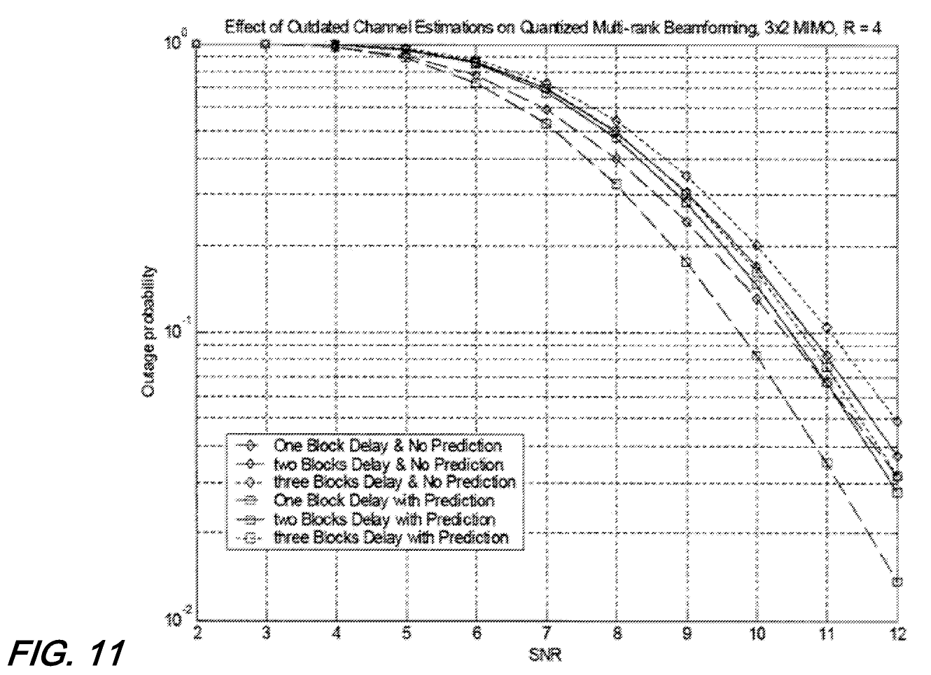

The estimation error naturally occurs because of the use of finite pilot signals in the channel and the existence of a delay between the frame for which the channel is estimated and the frame in which the estimate is used. While the first cause generates a finite error in the estimation variance that is relatively negligible, the latter cause may considerably reduce the gain of multi-rank beamforming. It is shown that the smaller the delay, the greater the gain restored with channel prediction. FIG. 11 shows the effect of the outdated channel estimation due to delay in the feedback link. FIG. 11 also shows the effect of using channel prediction.

As discussed above, known approaches to space adaptation for multiple-antenna systems include: (1) space-time coding, (2) preceding, and (3) beamforming. Space-time coding does not use any channel state information at the transmitter, whereas the other two schemes need channel state information at the transmitter that can be obtained through a low rate feedback, as described above.

With conventional preceding, the transmitted signal is given by:
X=\sqrt{P/k}[V⁽¹⁾;V⁽²⁾; . . . ;V^{(k)}][x₁,x₂, . . . , xₖ], (15)
and there is no power control performed on the transmission along different eigenvectors. Moreover, the transmission rate does not normally play a role in determining the rank of the precoder. Conventional preceding is normally full rank, however, in accordance with an exemplary embodiment of the present invention a multi-rank preceding may be used depending on the transmission rate, available power and channel conditions. While multi-rank beamforming uses quantized power control for transmission of different streams, multi-rank preceding uses equal power for all streams.

Conventional beamforming techniques consider only the dominant eigenvector of the channel, where all the power is used for the transmission of a single stream along this eigenvector of the channel as X_{t×1}=x·\sqrt{P}C_{t×1}. In this case, the problem of codebook design is then a simple vector packing problem in the space of C^{t}.

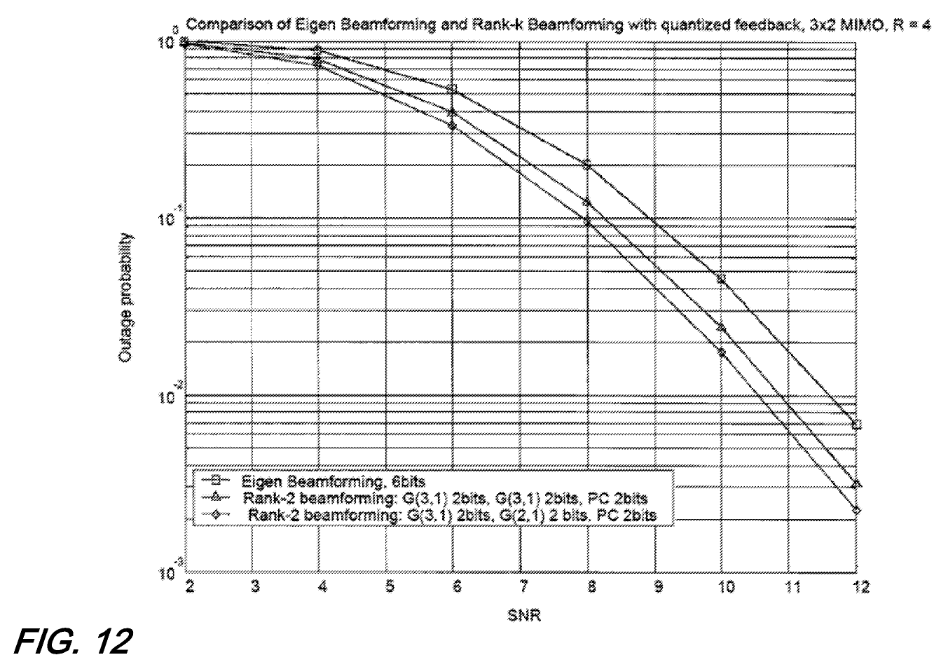

In conventional approaches, the rank is fixed or the power is not controlled along eigenvectors. FIG. 12 shows the improvement attained with two exemplary rank-2 beamforming schemes in accordance with the present invention over a conventional, dominant-eigenvector beamforming scheme for a 3×2 multiple-antenna system. Each of the schemes depicted in FIG. 12 uses a total of six bits of feedback. In FIG. 12, a conventional beamforming scheme with codebook size of 64 vectors in G(3,1) is compared to two different versions of multi-rank beamforming. In the first version, only one codebook of size 4 is used to quantize each eigenvector separately and the power over the eigenvectors is controlled through an additional 2 bits of feedback. In the second version, successive beamforming is performed by using two different codebooks, each of size 4, where one is in G(3,1) and the other in G(2,1). FIG. 12 shows the relative gain of multi-rank beamforming with or without successive beamforming over conventional dominant eigen-beamforming.

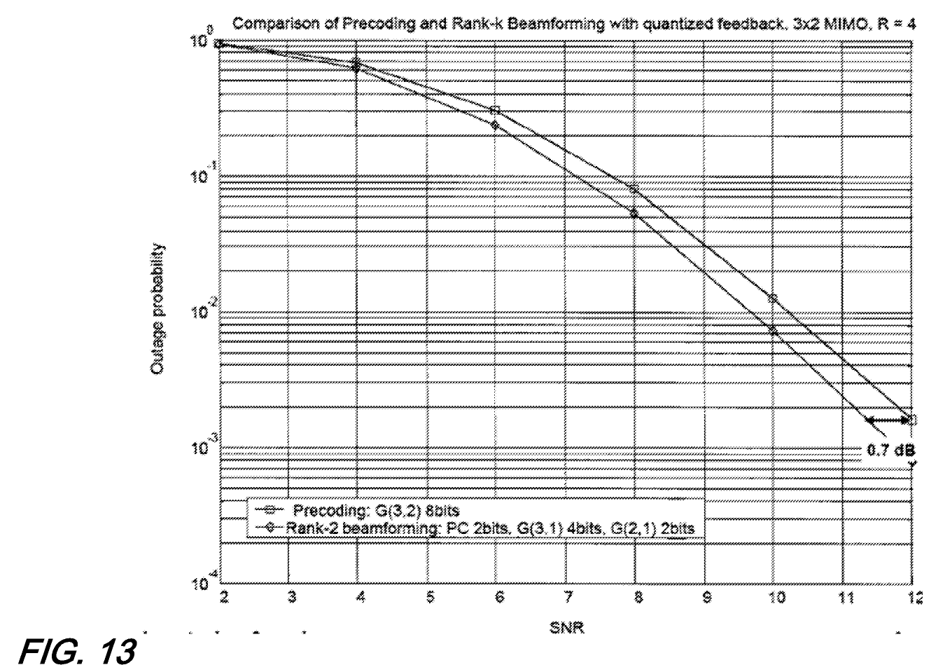

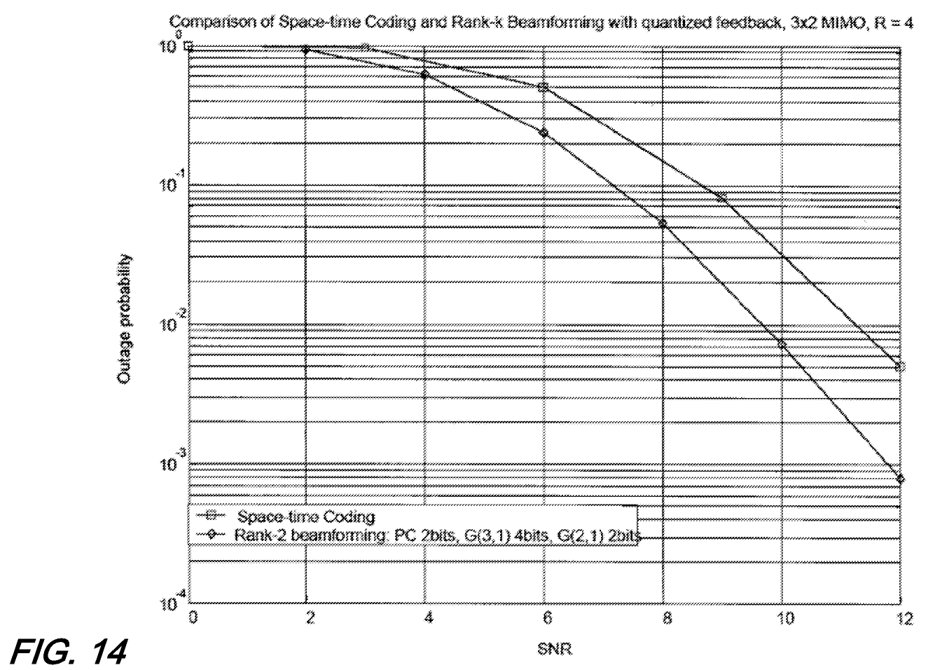

FIGS. 13 and 14 show the performance gain of an exemplary quantized multi-rank beamforming scheme over a quantized preceding scheme and a space-time coding scheme, respectively.

The principles of the present invention can be applied to a variety of communications systems, including, for example, UMTS Terrestrial Radio Access Network (UTRAN) and Evolved-UTRA, which call for higher user data rates and better quality of service, resulting in an improved overall throughput and better coverage.

An exemplary embodiment of a multi-user, multiple-antenna scheme in accordance with the present invention will now be described. In accordance with the exemplary scheme, a single user is scheduled for each block of downlink transmission. Moreover, the scheme selects an appropriate number of independent transmission streams based on the rank of the channel; i.e., the rank corresponds to the number of possible independent transmission streams. An appropriate rank selection can considerably improve the transmission rate. In an exemplary embodiment of the present invention, rank is selected based on the channel condition and transmission rate to maximize throughput. A suitable rank selection method is described in U.S. Provisional Patent Application No. 60/743,290, filed on Feb. 13, 2006, the entire contents of which are hereby incorporated by reference for all purposes into this application.

The exemplary scheme can preferably operate in two different modes: (i) it may differentiate between the supported number of transmitted streams and send an independent codeword for each stream by performing rate control per each stream; or (ii) it may choose a single rate and code a single codeword across all possible streams.

In a first aspect, the exemplary scheme employs rank selection with rank-specific codebooks. Using a different codebook for each rank yields considerable performance improvement.

In a further aspect, the exemplary scheme of the present invention includes a vector of power allocation ratios for each multi-rank preceding matrix where this power allocation vector specifies the ratio of the power to be used for transmission of each column of the corresponding multi-rank precoding matrix. For transmission rank k, the preceding matrix has k columns, where the columns of the precoding matrix correspond to the quantized values of the first k dominant eigenvectors of the channel.

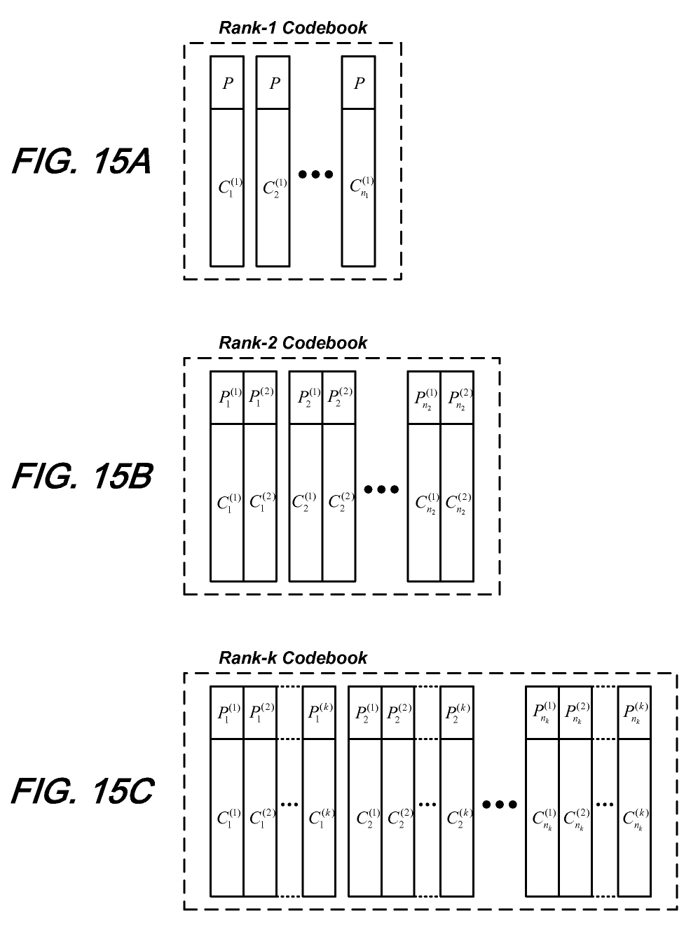

FIGS. 15A-C illustrate an exemplary codebook structure, in accordance with the present invention, which takes the aforementioned aspects into account. As shown in FIGS. 15A-C, the codebook structure includes a codebook for each selected rank of the transmission. The rank-1 codebook shown in FIG. 15A comprises n₁ columns, each column containing a quantized eigenvector C⁽¹⁾ with a corresponding power allocation ratio P. Note, however, that since for rank-1 beamforming only one eigenvector is used at a time, each eigenvector is allocated full power; i.e., P=1.

As shown in FIG. 15B, the rank-2 codebook comprises n₂ column pairs, each column pair containing a first quantized eigenvector C⁽¹⁾ and a second quantized eigenvector C⁽²⁾ with corresponding power allocation ratios P⁽¹⁾ and P⁽²⁾.

As shown in FIG. 15C, the codebook for rank-k comprises nₖ matrices, each matrix containing quantized eigenvectors C⁽¹⁾, C⁽²⁾, . . . , C^{(k)} with corresponding power allocation ratios P⁽¹⁾, P⁽²⁾, . . . , P^{(k)}. Each of the nₖ matrices is preferably an orthonormal k-frame, augmented with the vector of the power allocation ratios (as determined per (12)-(14), above). An orthonormal k-frame comprises k ordered complex orthonormal vectors corresponding to the first k dominant eigenvectors of the channel. Each k-frame is augmented with a power allocation vector which is a real unit-norm vector of size k in which the j^{th} element corresponds to the fraction of the power used for the j^{th} eigenvector of the channel. The k ordered complex orthonormal vectors are selected from the codebooks of the successive dominant eigenvector. For each possible orthonormal k-frame, there may be different power allocations. Therefore each entry of the codebook comprises an orthonormal k-frame augmented with each possible power control vector. Each such codebook entry is referred to herein as an augmented orthonormal k-frame (AOKF). The rank-k beamforming codebook may be comprised of all possible combinations of k-rank AOKFs.

Each column of the rank-1 codebook of FIG. 15A, and each column pair of the rank-2 codebook of FIG. 15B, can be an AOKF. The rank-1, rank-2, and rank-k codebooks can be treated as one codebook, with each AOKF identified by an index number which is fed-back from the receiver to the beamforming transmitter.

Because the codebook is rank-specific, there are different AOKF for different ranks. Moreover, the number of possible AOKF (i.e., n₁, n₂, . . . , nₖ) may be different for different ranks. The total number of all AOKF denotes the size of the codebook for the multi-rank beamforming strategy and is chosen, for example, based on the feed-back requirements. For example, the codebook for a 4×4 MIMO system may include 64, 32, 16, and 16 AOKFs for the transmission ranks of 4, 3, 2, and 1, respectively. The size of this codebook is then 128, with each AOKF identified by a 7-bit index which is to be fed-back. The value of the index thus also conveys information about the transmission rank.

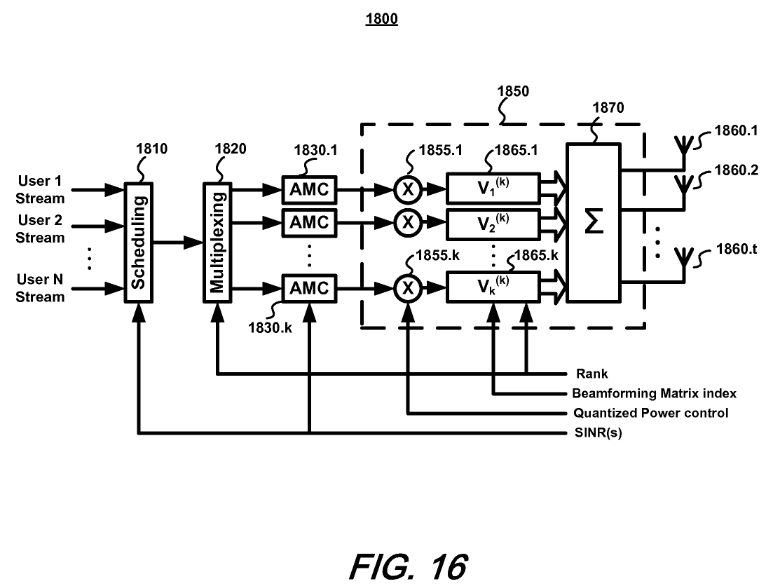

FIG. 16 is a block diagram of an exemplary embodiment of a base station 1800 incorporating multi-rank beamforming in accordance with the present invention. The base station 1800 comprises a scheduler 1810, a multiplexer 1820, multiple Adaptive Modulation and Coding scheme blocks (AMC) 1830.1-1830.k, and a beamforming block 1850 driving multiple transmit antennas 1860.1-1860.t. The beamforming block 1850 comprises power controllers 1855.1-1855.k, which scale the power of the signals for each stream to be transmitted along k different eigenvectors 1865.1-1865.k which are then combined in 1870 and transmitted by the transmit antennas 1860.1-1860.t.

The various blocks of the base station 1800 operate in accordance with information fed-back from UE (not shown), including, for example, rank, beamforming matrix index, quantization power control and Signal to Interference and Noise Ratio (SINR). The rank, beamforming matrix index, and power control can be conveyed, as described above, by the AOKF index. The SINR information fed-back from the UE is used by the base station to schedule the users depending on the scheduling criteria. Based on the rank feedback, the multiplexer block 1820 generates the appropriate number of signal streams and the AMC blocks 1830 choose the corresponding modulation and coding for each stream.

Different feedback overhead may be incurred if the transmission occurs with a single codeword (i.e., by coding across all the transmitted streams with the same codeword), or by transmission of multiple codewords (i.e., one for each stream). In the single codeword case, only one SINR value is fed back, whereas in the multiple codeword case, multiple SINR values are fed back, thereby increasing feedback overhead.

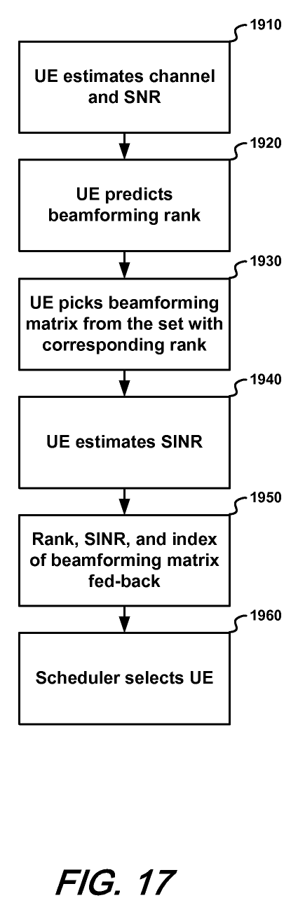

FIG. 17 is a flow-chart illustrating an exemplary interaction between the UE and a base station operating in accordance with the present invention. At step 1910 each UE estimates the channel and its SNR. Based on the rate requirement (usually chosen from a finite set of rates) each UE, at 1920, predicts the beamforming rank that maximizes its throughput. The UE, at 1930, then selects an AOKF beamforming matrix from the codebook of the corresponding rank. At 1940, the UE estimates one SINR value, for single code word (SCW) operation, or multiple SINR values, for multiple code word (MCW) operation, with one SINR value estimated for each eigenvector. At 1950, the SINR value(s), rank, and beamforming matrix index (of the selected AOKF) are fed-back from the UE to the base station. At 1960, the base station scheduler selects a UE, such as the UE with the highest supportable rate or as determined by one or more other measures.

It is understood that the above-described embodiments are illustrative of only a few of the possible specific embodiments which can represent applications of the invention. Numerous and varied other arrangements can be made by those skilled in the art without departing from the spirit and scope of the invention.

What is claimed is:

1. A beamforming transmission method for a multi-antenna communications system comprising:
estimating a channel over which the multi-antenna communications system is to operate;
determining a number of signal streams to be transmitted based on the estimated channel;
determining an eigenvector corresponding to each signal stream;
quantizing each eigenvector to determine a corresponding quantized eigenvector; and
transmitting each of the signal streams in accordance with the corresponding quantized eigenvector.

2. The beamforming transmission method of claim 1, comprising determining a power allocation over the number of signal streams, wherein the signal streams are transmitted further in accordance with the power allocation.

3. The beamforming transmission method of claim 1, comprising feeding back information relating to the two or more quantized eigenvectors from a receiver to a transmitter of the multi-antenna communications system.

4. The beamforming transmission method of claim 2, comprising feeding back information relating to the two or more quantized eigenvectors and the power allocation from a receiver to a transmitter of the multi-antenna communications system.

5. The beamforming transmission method of claim 1, wherein determining the eigenvector corresponding to each signal stream includes selecting the eigenvectors corresponding to the largest eigenvalues.

6. The beamforming transmission method of claim 1, wherein the step of quantizing includes successive quantization.

7. The beamforming transmission method of claim 2, wherein the power allocation is determined in accordance with a water-filling procedure.

8. The beamforming transmission method of claim 4, wherein the information relating to the two or more quantized eigenvectors and the power allocation is provided as an index identifying an entry of a codebook known to the receiver and the transmitter.

9. The beamforming transmission method of claim 8, wherein the codebook comprises a plurality of entries, each entry including a quantized eigenvector for each of a plurality of beamforming ranks.

10. The beamforming transmission method of claim 9, wherein each codebook entry includes a power allocation vector, the power allocation vector specifying the power allocation for each of the quantized eigenvectors.

11. The beamforming transmission method of claim 9, wherein the quantized eigenvectors of each codebook entry are contained in an orthonormal k-frame.

12. The beamforming transmission method of claim 6, wherein a quantized eigenvector is determined as a function of its corresponding eigenvector and a quantized eigenvector of lower rank.

13. The beamforming transmission method of claim 6, wherein a quantized eigenvector is re-created as a function of the quantized eigenvector and a quantized eigenvector of lower rank.
